(19) United States
(12) Patent Application Publication
(10) Pub. No.: US 2018/0210269 A1
(43) Pub. Date: Jul. 26, 2018

(54) FRAME, BACKLIGHT MODULE, AND LIQUID CRYSTAL DISPLAY DEVICE

(71) Applicant: Wuhan China Star Optoelectronics Technology Co., Ltd., Wuhan, Hubei (CN)

(72) Inventor: Jie Zeng, Wuhan, Hubei (CN)

(73) Assignee: Wuhan China Star Optoelectronics Technology Co., Ltd., Wuhan, Hubei (CN)

(21) Appl. No.: 15/327,467

(22) PCT Filed: Dec. 27, 2016
(86) PCT No.: PCT/CN2016/112225

§ 371 Date: Jan. 19, 2017

(30) Foreign Application Priority Data
Dec. 19, 2016 (CN) 201611178165.3

(51) Int. Cl. G02F 1/1333; G02F 1/1335; F21V 8/00

(52) U.S. Cl. CPC G02F 1/133308; G02F 1/133605; G02F 1/133603; G02F 2001/133314; G02B 6/0088; G02F 2001/133317; G02F 1/133608

(57) ABSTRACT

Disclosed are a frame, a backlight module, and a liquid crystal display device. The frame has an accommodation space which is configured to accommodate a light guide plate, and one side of the frame is provided with a reflection positioning structure, which corresponds to a light incident side of the light guide plate. The reflection positioning structure has a plurality of LED placement grooves in which LEDs are placed, and an open end of each LED placement groove is located on one side of the frame parallel to the light guide plate. Each LED placement groove is provided with an LED light outlet hole on one side thereof near the light guide plate, and the reflection positioning structure is provided with a reflective layer on one side thereof near the light guide plate. The frame of the present disclosure can reflect light leaking from the light guide plate back to the light guide plate so as to increase the light utilization efficiency. The strength of the entire frame can be increased and the frame is not easy to deform, which facilitates positioning and installation of the light guide plate. The frame in the present disclosure is optimally applied in small and medium sized mobile phones and tablets, and a much better display effect can be obtained with respect to a light guide plate with a longer side thereof as a light incident side.

### CROSS-REFERENCE TO RELATED APPLICATIONS

This application claims the priority of Chinese patent application CN201611178165.3, entitled “Frame, backlight module, and liquid crystal display device” and filed on Dec. 19, 2016, the entirety of which is incorporated herein by reference.

### FIELD OF THE INVENTION

The present disclosure relates to the technical field of liquid crystal display devices, and in particular, to a frame, a backlight module, and a liquid crystal display device.

### BACKGROUND OF THE INVENTION

At present, liquid crystal display devices are widely used as display components in variety kinds of electronic products, and a backlight module is an important component in a liquid crystal display device.

In general, as shown in FIG. 1, a small and medium sized backlight module (different from a large sized ones) comprises a frame 101, a reflective sheet 102, a light guide plate 103, an optical diaphragm group 104, a light source flexible printed circuit 105 (FPC), an LED 106, a light-shielding tape 107, and a display screen 108. The light source flexible printed circuit 105 and the LED 106 are fixed to the light guide plate 103 and the frame 101 through the light-shielding tape 107, and the optical diaphragm group 104 is fixed to the frame 101 through the light-shielding tape 107. The reflective sheet 102 is attached to a bottom surface of the frame 101 through the light-shielding tape 107, and the display screen 108 is attached to the light-shielding tape. For further intuitive understanding, reference can be made to a three dimensional view of the backlight module in FIG. 2 (the light guide plate and the optical diaphragm group are not shown). The light guide plate is located by projections 109 on one side of the frame, and the LED 106 is placed in a gap between the projections 109 of the frame 101. However, when there are a few number of LEDs, a spot problem would easily occur to the backlight, as shown in FIG. 3. First, light outlet areas are brighter.

That is, in FIG. 3, bright areas 111 correspond to the light outlet areas of LED 106, and areas between each of two adjacent bright areas 111 are dark areas 112. Second, light 113 which leaks from gaps among LEDs 106 cannot be utilized.

### SUMMARY OF THE INVENTION

The purpose of the present disclosure is to provide a frame, a backlight module and a liquid crystal display device which can improve a light utilization efficiency and achieve a better positioning of a light guide plate.

In order to achieve the aforesaid purpose, the present disclosure provides a frame. The frame has an accommodation space which is configured to accommodate a light guide plate. One side of the frame is provided with a reflection positioning structure which corresponds to a light incident side of the light guide plate. The reflection positioning structure has a plurality of LED placement grooves in which LEDs are placed, and an open end of each LED placement groove is located on one side of the frame parallel to the light guide plate. Each LED placement groove is provided with an LED light outlet hole on one side thereof near the light guide plate, and the reflection positioning structure is provided with a reflective layer on one side thereof near the light guide plate. The reflective layer can reflect light leaking from the light guide plate back to the light guide plate. That is, the reflective layer can reflect light that cannot be utilized in a backlight module in the prior art back to the light guide plate, so that the light can be reused. Besides, this structure facilitates installation and positioning of the light guide plate. This is because a strength of the entire frame can be increased by arranging the reflection positioning structure, and the frame is not easy to deform. A size of the light guide plate can better match a size of the accommodation space of the frame.

In the frame, a wall of the LED light outlet hole is provided with a reflective layer, so that a reflection effect can be further improved.

In the frame, a size of the LED light outlet hole is equal to a size of an LED light outlet surface. Since the size of the light outlet hole is less than a size of each LED, the LED cannot fall off from the light output hole and a structural stability can be ensured. Since the size of the light outlet hole is reduced to the size of each LED light outlet surface, an area of the reflective layer can be increased and light leakage phenomenon can be greatly reduced.

In the frame, a size of each of the LED placement grooves is equal to a size of each which therefore facilitates fixture of the LEDs.

In the frame, a size of the light guide plate is equal to a size of the accommodation space of the frame, which facilitates fixture of the light guide plate.

In the frame, the plurality of LED placement grooves are arranged with an equal distance thereamong.

In the frame, at least two LEDs are placed in each LED placement groove, and each LED placement groove is provided with light outlet holes with a number equal to a number of the LEDs.

In the frame, each LED placement groove is provided with a closed end which is arranged opposite to the open end.

The present disclosure further provides a backlight module, which comprises the aforesaid frame.

The present disclosure further provides a liquid crystal display device, which comprises the aforesaid backlight module.

The present disclosure has the beneficial effects as follows.

1. The light leaking from the light guide plate can be reflected back to the light guide plate, so that the light utilization efficiency can be increased.

2. The strength of the entire frame can be increased and the frame is not easy to deform, which facilitates the positioning and installation of the light guide plate.

3. The frame is optimally applied in small and medium sized mobile phones and tablets, and a much better display effect can be obtained with respect to a light guide plate with a longer side thereof as a light incident side.

### BRIEF DESCRIPTION OF THE DRAWINGS

The present disclosure will be described in a more detailed way below based on embodiments and with reference to the accompanying drawings, in the drawings:

FIG. 1 schematically shows a structure of a backlight module in the prior art;

FIG. 2 is a three dimensional view of the backlight module in the prior art (a light guide plate and an optical diaphragm group are not shown);

schematically shows a spot problem during application of the backlight module in the prior art;

FIG. 4 is a three dimensional view of a frame according to a first embodiment of the present disclosure;

FIG. 5 is a three dimensional view of a part of the frame according to the first embodiment of the present disclosure;

FIG. 6 is a three dimensional view of a frame according to a second embodiment of the present disclosure; and

FIG. 7 is a three dimensional view of a part of the frame according to the second embodiment of the present disclosure.

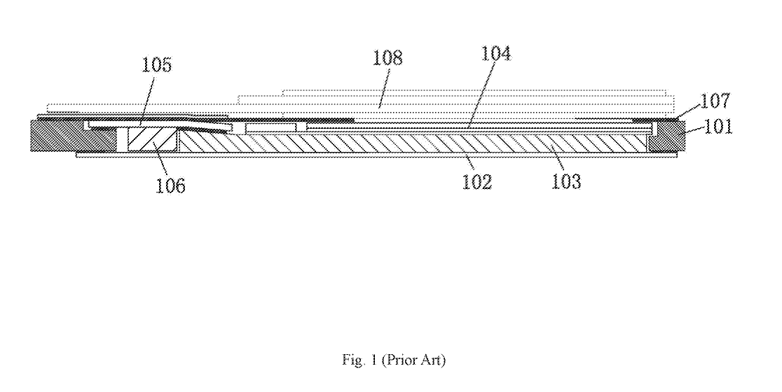

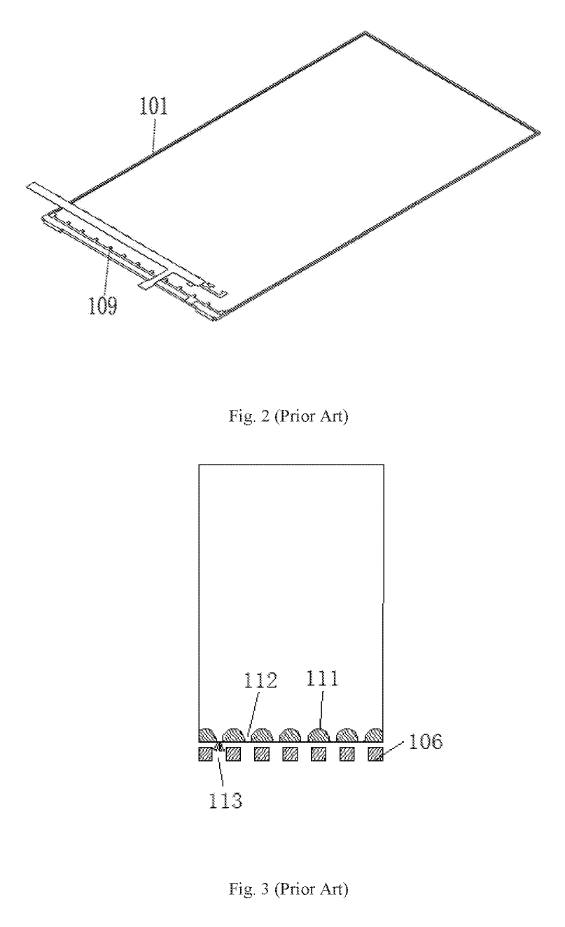

In the accompanying drawings, same components use same reference signs. The accompanying drawings are not drawn according to actual proportions.

### DETAILED DESCRIPTION OF THE EMBODIMENTS

The present disclosure will be further explained hereinafter in combination with the accompanying drawings.

### Embodiment 1

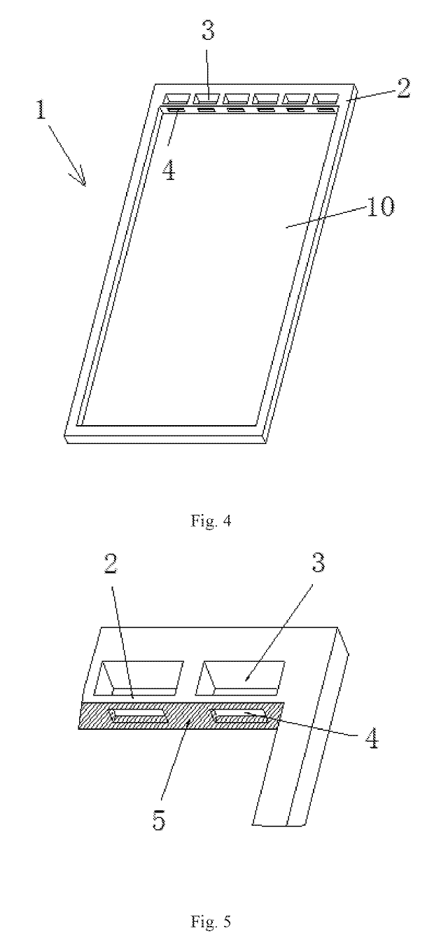

As shown in FIGS. 4 and 5, the present disclosure provides a frame 1, which is a rectangular frame. An accommodation space 10 in the rectangular frame is configured to accommodate a light guide plate and LEDs (which are not shown in FIGS. 4 and 5). One side of the frame 1 is provided with a reflection positioning structure 2 which corresponds to a light incident side of the light guide plate.

Specifically, as shown in FIG. 5, the reflection positioning structure 2 has a plurality of LED placement grooves 3 which are distributed with an equal distance thereamong along one side of the frame 1. Each LED placement groove 3 has an open end, which is located on one side of the frame parallel to the light guide plate (according to other embodiments, the open end can be arranged on other sides of the frame) and is configured to accommodate the LEDs. Another side opposite to the open end is a closed end, which prevents the LED from falling off from the closed end. Preferably, a size of each of the LED placement grooves 3 is equal to a size of each LED. Besides, each of the LED placement grooves 3 is provided with an LED light output hole 4 on one side thereof near the light guide plate, and each LED light output hole 4 corresponds to each light outlet surface of the LED. The one-to-one design of the LEDs and the LED placement grooves enables LEDs to be fixed in the LED placement grooves 3, and the LED light outlet surface can be easily aligned with the LED light output hole 4. In addition, the LED is easy to place and easy to operate due to the design of the open end. When the frame is assembled, the open ends of the LED placement grooves 3 will be closed by a structure above the frame, and the LEDs will be fixed in the LED placement grooves. Alternatively, members for locking the LEDs can be arranged at the open ends so that the LEDs cannot fall out from the open ends.

The reflection positioning structure 2 is provided with a reflective layer 5 on one side thereof near the light guide plate, and a wall of the LED light outlet hole 4 is provided with a reflective layer 5. That is, a whole surface of the reflection positioning structure 2 which contacts the light guide plate and internal surfaces of the LED light outlet hole are all covered with the reflective layer 5.

During installation, a plurality of LEDs are placed into corresponding LED placement grooves 3 through the open ends in sequence. It is ensured that the LED light outlet surface is aligned with the LED light outlet hole 4 of the reflection positioning structure 2, so that light can enter into the light guide plate smoothly. The reflective layer 5 of the reflection positioning structure 2 can reflect light leaking from the light guide plate back to the light guide plate. That is, the reflective layer can reflect light that cannot be utilized in a prior backlight module back to the light guide plate, so that the light can be reused. Besides, this structure facilitates installation and positioning of the light guide plate. This is because a strength of the entire frame can be increased by arranging the reflection positioning structure 2, and the frame is not easy to deform. A size of the light guide plate can better match a size of the accommodation space 10 of the frame 1.

Since an actual size of the LED light outlet surface is less than a size of a surface of an LED which faces the light guide plate, preferably, a size of the light outlet hole 4 of the reflection positioning structure 2 is equal to the size of the LED light outlet surface, while less than the size of the surface of the LED which faces the light guide plate. Such design has advantages as follows. First, since the size of the light outlet hole 4 is less than a size of each LED, the LED cannot fall off from the light output hole 4 and a structural stability can be ensured. Second, since the size of the light outlet hole 4 is reduced to the size of each LED light outlet surface, an area of the reflective layer 5 can be increased and light leakage phenomenon can be greatly reduced.

### Embodiment 2

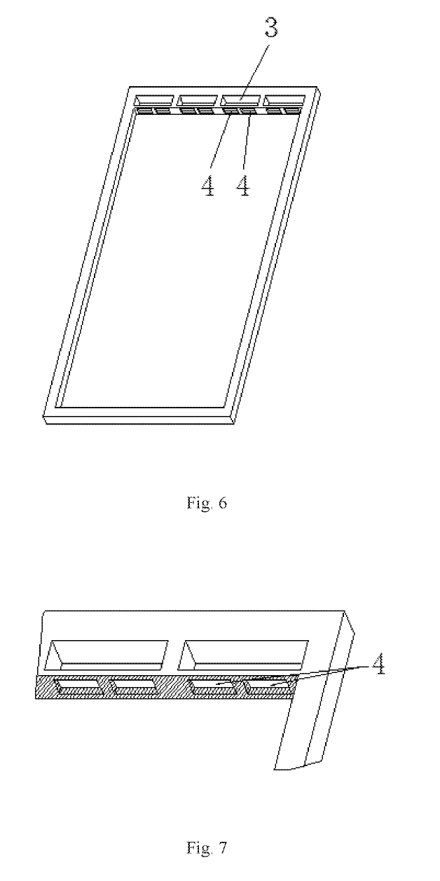

As shown in FIGS. 6 and 7, the second embodiment differs from the first embodiment in that, each LED placement groove 3 can be configured to accommodate at least two LEDs, and each LED placement groove 3 is provided with at least two LED light outlet holes 4 corresponding to the LEDs on one side thereof near the light guide plate. Each LED light outlet hole 4 corresponds to each light outlet surface of the LED.

According to the second embodiment, by combining at least two of the adjacent LED placement grooves 3 of the first embodiment into one, a reflection positioning structure can be more easily manufactured.

### Embodiment 3

The third embodiment differs from the first embodiment in that, a number of LED placement groove is one. That is, all LEDs are placed in one communicated LED placement groove 3, and the LED placement groove 3 is provided with a corresponding number of LED light outlet holes 4 on one side thereof near the light guide plate. Each LED light outlet hole 4 corresponds to each light outlet surface of the LED. It is much easier to produce a reflection positioning structure in the third embodiment.

The present disclosure further provides a backlight module, which comprises the frame according to any one of the above embodiments.

In summary, the present disclosure has the beneficial effects as follows.

1. The light leaking from the light guide plate can be reflected back to the light guide plate, so that the light utilization efficiency can be increased.

2. The strength of the entire frame can be increased and the frame is not easy to deform, which facilitates the positioning and installation of the light guide plate.

3. The frame is optimally applied in small and medium sized mobile phones and tablets, and a much better display effect can be Obtained with respect to a light guide plate with a longer side thereof as a light incident side.

The present disclosure is explained in detail in combination with preferred embodiments hereinabove, but the embodiments disclosed herein can be improved in any way and the parts thereof can be substituted with their equivalents without departing from the protection scope of the present disclosure. In particular, as long as there are no structural conflicts, the technical features disclosed in each and every embodiment of the present disclosure can be combined with one another in any way, and the combined features formed thereby are within the protection scope of the present disclosure. The present disclosure is not limited by the specific embodiments disclosed herein, but includes all technical solutions falling into the protection scope of the claims.

1. A frame, having an accommodation space which is configured to accommodate a light guide plate, wherein one side of the frame is provided with a reflection positioning structure which corresponds to a light incident side of the light guide plate;
wherein the reflection positioning structure has a plurality of LED placement grooves in which LEDs are placed, and an open end of each LED placement groove is located on one side of the frame parallel to the light guide plate; and
wherein each LED placement groove is provided with an LED light outlet hole on one side thereof near the light guide plate, and the reflection positioning structure is provided with a reflective layer on one side thereof near the light guide plate.

2. The frame according to claim 1, wherein a wall of the LED light outlet is provided with a reflective layer.

3. The frame according to claim 1, wherein a size of the LED light outlet hole is equal to a size of an LED light outlet surface.

4. The frame according to claim 1, wherein a size of each of the LED placement grooves is equal to a size of each LED.

5. The frame according to claim 1, wherein a size of the light guide plate is equal to a size of the accommodation space of the frame.

6. The frame according to claim 1, wherein the plurality of LED placement grooves are arranged with an equal distance thereamong.

7. The frame according to claim 1, wherein at least two LEDs are placed in each LED placement groove, and each LED placement groove is provided with LED light outlet holes with a number equal to a number of the LEDs.

8. The frame according to claim 1, wherein each LED placement groove is provided with a closed end which is arranged opposite to the open end.

9. A backlight module, wherein the backlight module comprises the frame according to claim 1.

10. A backlight module, wherein the backlight module comprises the frame according to claim 2.

11. A backlight module, wherein the backlight module comprises the frame according to claim 3.

12. A backlight module, wherein the backlight module comprises the frame according to claim 4.

13. A backlight module, wherein the backlight module comprises the frame according to claim 5.

14. A backlight module, wherein the backlight module comprises the frame according to claim 6.

15. A backlight module, wherein the backlight comprises the fray according to claim 7.

16. A backlight module, wherein the backlight module comprises the frame according to claim 8.

17. A liquid crystal display device, wherein the liquid crystal display device comprises the backlight module according to claim 9.

18. A liquid crystal display device, wherein the liquid crystal display device comprises the backlight module according to claim 10.

19. A liquid crystal display device, wherein the liquid crystal display device comprises the backlight module according to claim 11.

20. A liquid crystal display device, wherein the liquid crystal display device comprises the backlight module according to claim 12.
